(19) United States
(12) Patent Application Publication
(10) Pub. No.: US 2023/0142458 A1
(43) Pub. Date: May 11, 2023

(54) HIGH MELT STRENGTH POLYESTER RESIN COMPOSITION AND MANUFACTURING METHOD THEREOF

(71) Applicant: NAN YA PLASTICS CORPORATION, Taipei (TW)

(72) Inventors: Te-Chao Liao, TAIPEI (TW); Ching-Yao Yuan, TAIPEI (TW); Wei Tang Liao, TAIPEI (TW)

(73) Assignee: NAN YA PLASTICS CORPORATION, TAIPEI (TW)

(21) Appl. No.: 17/580,584

(22) Filed: Jan. 20, 2022

(30) Foreign Application Priority Data
Nov. 8, 2021 (TW) 110141471

(51) Int. Cl. C08L 67/02; C08J 3/22

(52) U.S. Cl. CPC C08L 67/02; C08J 3/226; C08L 2310/00; C08J 2367/00; C08J 2423/02

(57) ABSTRACT

The disclosure provides a high melt strength polyester resin composition and a manufacturing method thereof. The high melt strength polyester resin composition includes a polyester resin, a polyolefin resin, a chain extender, an antioxidant, and a phosphorus compound stabilizer. A melting point of the polyester resin is 150° C. to 200° C.

### CROSS-REFERENCE TO RELATED APPLICATION

This application claims the priority benefit of Taiwan application serial no. 110141471, filed on Nov. 8, 2021. The entirety of the above-mentioned patent application is hereby incorporated by reference herein and made a part of this specification.

### BACKGROUND

### Technical Field

The disclosure relates to a polyester resin composition and a manufacturing method thereof, and more particularly, to a high melt strength polyester resin composition and a manufacturing method thereof.

### Description of Related Art

Polyethylene terephthalate (referred to as PET) is the material with the largest production and the lowest price in thermoplastic polyester, which has excellent physical, chemical, and mechanical properties, as well as good resistance to organic solvents and weather resistance, and is widely applied in fields such as fiber textile, film, and container manufacturing. In recent years, PET has also shown a wide range of application prospects in the field of foam materials. The PET foam material has advantages of light weight, high specific strength, high rigidity, good electrical insulating property, and good sound insulation and heat insulation, which may be applied in fields such as food packaging, microwave containers, building materials, sports equipment, automobiles, aviation, and aerospace. However, PET is a semi-crystalline polymer with a linear molecular chain. During processing, PET may only flow at a temperature higher than its melting point. At this time, the melt strength and melt viscosity of PET are very small. In addition, at high temperatures, PET is easily degraded, resulting in a decrease in the molecular weight, and melt rheology further deteriorates, which is unable to support the growth and shaping of cells in the PET matrix. Therefore, in general, conventional PET may not obtain good cell material during the foaming process.

How to improve the melt strength of PET is an important research. The main factors affecting the melt strength of PET are the molecular weight, molecular weight distribution, and long-chain branching degree of PET. Therefore, PET must be modified to increase the molecular weight of PET, broaden the molecular weight distribution, and increase the long-chain branching degree.

### SUMMARY

The disclosure provides a high melt strength polyester resin composition and a manufacturing method thereof, which may effectively solve an issue of the melt strength of PET.

The high melt strength polyester resin composition in the disclosure includes a polyester resin, a polyolefin resin, a chain extender, an antioxidant, and a phosphorus compound stabilizer. A melting point of the polyester resin is 150° C. to 200° C.

In an embodiment of the disclosure, the chain extender includes dianhydrides and polyepoxides of tetracarboxylic aromatic hydrocarbons, polycarboxylic aromatic hydrocarbons, or fatty acids.

In an embodiment of the disclosure, the antioxidant includes a hindered phenol antioxidant or a phosphite antioxidant.

In an embodiment of the disclosure, based on a total weight of a content of the polyester resin composition calculated as 100 wt %, a content of the polyester resin is 30 wt % to 93.8 wt %, a content of the polyolefin resin is 5 wt % to 68.8 wt %, a content of the chain extender is 1 wt % to 20 wt %, a content of the antioxidant is 0.1 wt % to 3 wt %, and a content of the phosphorus compound stabilizer is 0.1 wt % to 1 wt %.

The manufacturing method of the polyester resin composition in the disclosure includes the following steps. The polyester resin, the polyolefin resin, the chain extender, the antioxidant, and the phosphorus compound stabilizer are uniformly mixed, and then mixed by a kneader to be granulated. The melting point of the polyester resin is 150° C. to 200° C.

In an embodiment of the disclosure, a processing temperature of the kneader is 150° C. to 200° C.

In an embodiment of the disclosure, the chain extender includes dianhydrides and polyepoxides of tetracarboxylic aromatic hydrocarbons, polycarboxylic aromatic hydrocarbons, or fatty acids.

In an embodiment of the disclosure, the antioxidant includes a hindered phenol antioxidant or a phosphite antioxidant.

In an embodiment of the disclosure, based on a total weight of a total usage amount of each component calculated as 100 wt %, an additive amount of the polyester resin is 30 wt % to 93.8 wt %, an additive amount of the polyolefin resin is 5 wt % to 68.8 wt %, an additive amount of the chain extender is 1 wt % to 20 wt %, an additive amount of the antioxidant is 0.1 wt % to 3 wt %, and an additive amount of the phosphorus compound stabilizer is 0.1 wt % to 1 wt %.

Based on the above, the high melt strength polyester resin composition in the disclosure includes the polyolefin resin. Therefore, a discontinuous phase may be formed in a masterbatch to facilitate the dispersion of the chain extender and further contribute to the subsequent foaming process. On the other hand, the manufacturing method of the polyester resin composition in the disclosure lowers the processing temperature (150° C. to 200° C.), so that the chain extender may be processed without sublimation.

### DETAILED DESCRIPTION OF DISCLOSED EMBODIMENTS

Hereinafter, embodiments of the disclosure will be described in detail. However, these embodiments are illustrative, and the disclosure is not limited thereto.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with any numerical value and a smaller numerical range thereof in the specification.

The disclosure provides a high melt strength polyester resin composition, which includes a polyester resin, a polyolefin resin, a chain extender, an antioxidant, and a phosphorus compound stabilizer. In this embodiment, a melting point of the polyester resin is, for example, 150° C. to 200° C. Therefore, the polyester resin used in the disclosure is preferably, for example, the polyester resin with a low melting point. The chain extender may include dianhydrides and polyepoxides of tetracarboxylic aromatic hydrocarbons, polycarboxylic aromatic hydrocarbons, or fatty acids. The antioxidant may include a hindered phenol antioxidant or a phosphite antioxidant. The phosphorus compound stabilizer may include triphenyl phosphite or triethylene phosphorothioate.

In this embodiment, based on a total weight of a content of the polyester resin composition, for example, calculated as 100 wt %, a content of the polyester resin is, for example, 30 wt % to 93.8 wt %; a content of the polyolefin resin is, for example, 5 wt % to 68.8 wt %. %; a content of the chain extender is, for example, 1 wt % to 20 wt %; a content of the antioxidant is, for example, 0.1 wt % to 3 wt %, and a content of the phosphorus compound stabilizer is, for example, 0.1 wt % to 1 wt %.

The disclosure also provides a manufacturing method of the polyester resin composition, which includes the following steps. The polyester resin, the polyolefin resin, the chain extender, the antioxidant, and the phosphorus compound stabilizer are uniformly mixed, and then processed into a foamed chain extender masterbatch by a kneader. In this embodiment, a processing temperature of the kneader is preferably, for example, 150° C. to 200° C.

In this embodiment, based on a total weight of a total usage amount of each component, for example, calculated as 100 wt %, an additive amount of the polyester resin is, for example, 30 wt % to 93.8 wt %; an additive amount of the polyolefin resin is, for example, 5 wt % to 68.8 wt %. %; an additive amount of the chain extender is, for example, 1 wt % to 20 wt %; an additive amount of the antioxidant is, for example, 0.1 wt % to 3 wt %, and an additive amount of the phosphorus compound stabilizer is, for example, 0.1 wt % to 1 wt %.

Hereinafter, the high melt strength polyester resin composition and the manufacturing method thereof according to the disclosure is described below in detail by way of experimental examples. However, the following experimental examples are not intended to limit the disclosure.

### Experimental Example

In order to verify that the high melt strength polyester resin composition and the manufacturing method thereof according to the disclosure are helpful for a subsequent foaming process, the experimental examples are provided as follows.

### Example 1

A mixture of the polyester resin of 78.5 wt %, the polyolefin resin of 10 wt %, the chain extender of 10 wt %, the antioxidant of 1 wt %, and the phosphorus compound stabilizer of 0.5 wt % is uniformly mixed with a mixer, and then processed by the kneader to be granulated.

Processing conditions of the kneader:
The rotor speed: 60 rpm
The processing temperature:
The zone 1: 150° C.
The Zone 2: 170° C.
The zone 3: 170° C.
The processing time: 10 minutes

### Example 2

The processing is performed in the same manner as in Example 1. However, a proportion of the chain extender is increased to 20 wt %, and a proportion of the polyester resin is reduced to 68.5 wt %.

### Example 3

The processing is performed in the same manner as in Example 1. However, a proportion of the polyolefin resin is increased to 30 wt %.

### Comparative Example 1

The processing is performed in the same manner as in Example 1. However, the polyolefin resin is not used, and the polyester resin is 78.5 wt %.

Composition ratios of Examples 1 to 3 and Comparative Example 1 as well as the density and average cell size after foaming applied to the subsequent foaming process are shown in Table 1 below. Referring to Table 1, the high melt strength polyester resin composition according to the disclosure are used in Examples 1 to 3, which is helpful for the subsequent foaming process. In contrast, the polyolefin resin is not used in Comparative Example 1. Therefore, a discontinuous phase may not be formed in the masterbatch, so the technical effect of the disclosure that is helpful for dispersion of the chain extender may not be achieved, which is not helpful for the subsequent foaming process.

| | | | | Comparative |
|---|---|---|---|---|
| | Example | | | example |
| Composition (wt %) | 1 | 2 | 3 | 1 |
| The polyester resin | 78.5 | 68.5 | 58.5 | 78.5 |
| The polyolefin resin | 10 | 10 | 30 | 0 |
| The chain extender | 10 | 20 | 10 | 20 |
| The antioxidant | 1 | 1 | 1 | 1 |
| The phosphorus compound | 0.5 | 0.5 | 0.5 | 0.5 |
| stabilizer | | | | |

applied to the subsequent foaming process

| | | | | |
|---|---|---|---|---|
| The density after foaming | 0.135 | 0.127 | 0.129 | 0.288 |
| (g/cm³) | | | | |
| The average cell size | 93 | 88 | 81 | 151 |

Based on the above, the high melt strength polyester resin composition in the disclosure includes the polyolefin resin. Therefore, the discontinuous phase may be formed in the masterbatch to facilitate the dispersion of the chain extender and further contribute to the subsequent foaming process. On the other hand, the manufacturing method of the polyester resin composition in the disclosure lowers the processing temperature (150° C. to 200° C.), so that the chain extender may be processed without sublimation. In this way, the high melt strength polyester resin composition and the manufacturing method thereof in the disclosure may effectively solve the issue of the melt strength of PET.

What is claimed is:

1. A polyester resin composition, comprising:
a polyester resin with a melting point of 150° C. to 200° C.;
a polyolefin resin;
a chain extender;
an antioxidant; and
a phosphorus compound stabilizer.

2. The polyester resin composition according to claim 1, wherein the chain extender comprises dianhydrides and polyepoxides of tetracarboxylic aromatic hydrocarbons, polycarboxylic aromatic hydrocarbons, or fatty acids.

3. The polyester resin composition according to claim 1, wherein the antioxidant comprises a hindered phenol antioxidant or a phosphite antioxidant.

4. The polyester resin composition according to claim 1, wherein based on a total weight of a content of the polyester resin composition calculated as 100 wt %, a content of the polyester resin is 30 wt % to 93.8 wt %, a content of the polyolefin resin is 5 wt % to 68.8 wt %, a content of the chain extender is 1 wt % to 20 wt %, a content of the antioxidant is 0.1 wt % to 3 wt %, and a content of the phosphorus compound stabilizer is 0.1 wt % to 1 wt %.

5. A manufacturing method of a polyester resin composition, comprising:
uniformly mixing a polyester resin, a polyolefin resin, a chain extender, an antioxidant, and a phosphorus compound stabilizer to be processed into a masterbatch by a kneader,
wherein a melting point of the polyester resin is 150° C. to 200° C.

6. The manufacturing method of the polyester resin composition according to claim 5, wherein a processing temperature of the kneader is 150° C. to 200° C.

7. The manufacturing method of the polyester resin composition according to claim 5, wherein the chain extender comprises dianhydrides and polyepoxides of tetracarboxylic aromatic hydrocarbons, polycarboxylic aromatic hydrocarbons, or fatty acids.

8. The manufacturing method of the polyester resin composition according to claim 5, wherein the antioxidant comprises a hindered phenol antioxidant or a phosphite antioxidant.

9. The manufacturing method of the polyester resin composition according to claim 5, wherein based on a total weight of a total usage amount of each component calculated as 100 wt %, an additive amount of the polyester resin is 30 wt % to 93.8 wt %, an additive amount of the polyolefin resin is 5 wt % to 68.8 wt %, an additive amount of the chain extender is 1 wt % to 20 wt %, an additive amount of the antioxidant is 0.1 wt % to 3 wt %, and an additive amount of the phosphorus compound stabilizer is 0.1 wt % to 1 wt %.
